(19) United States
(12) Patent Application Publication
(10) Pub. No.: US 2026/0125065 A1
(43) Pub. Date: May 7, 2026

(54) SYSTEMS AND METHODS FOR VEHICLE SENSOR CALIBRATION IN A VEHICLE ASSEMBLY ENVIRONMENT

(71) Applicant: Ford Global Technologies, LLC, Dearborn, MI (US)

(72) Inventors: Parul Kothari, New Brunswick, NJ (US); Elizabeth Murphy, Austin, TX (US); Khalid Yousif, Milpitas, CA (US); Larry Lenkin, Bethesda, MD (US); Quan Zhou, Sunnyvale, CA (US); Sean Williams, Wexford, PA (US)

(73) Assignee: Ford Global Technologies, LLC, Dearborn, MI (US)

(21) Appl. No.: 18/934,980

(22) Filed: Nov. 1, 2024

(51) Int. Cl. B60W 50/00; B60W 60/00

(52) U.S. Cl. CPC B60W 50/00; B60W 60/001; B60W 2050/0083; B60W 2420/403; B60W 2420/408

(57) ABSTRACT

A method includes receiving detection data and Inertial Measurement Unit (IMU) data from a vehicle as the vehicle traverses a testing lane, wherein the detection data corresponds to lidar detections, camera detections, and radar detections, by one or more sensors of the vehicle, and the IMU data corresponds to a determination of one or more motion constraints from the one or more sensors and an IMU and a determination of one or more constraints between the IMU and the vehicle to generate. A plurality of targets are arranged with respect to the testing lane and have a plurality of calibration elements configured to allow detection by the one or more sensors of the vehicle. The method further includes processing the received detection data and IMU data using a calibration algorithm, and generating one or more calibration parameters for the one or more sensors of the vehicle based on the processing.

### FIELD

The present disclosure relates to calibrating sensors of a vehicle. More specifically, the present disclosure relates to calibrating vehicle sensors of a vehicle having autonomous operation capabilities.

### BACKGROUND

The statements in this section merely provide background information related to the present disclosure and may not constitute prior art.

A vehicle manufacturing environment may include one or more end-of-line (EOL) testing stations that are configured to calibrate and verify the functionality of various components of a vehicle. As an example, after the vehicle is assembled, a sensor calibration EOL station may calibrate one or more sensors of the vehicle. For example, a camera calibration EOL station may calibrate a forward-facing camera of the vehicle. However, the calibration EOL stations are unable to calibrate all sensors of the vehicle to allow for Level 3 (L3) autonomous driving operation upon delivery of the vehicle. That is, in addition to factory calibration, additional calibration is performed after the vehicle leaves the final assembly plant in order to calibrate the sensors to allow for L3 vehicle autonomy. These issues with factory calibration, among other issues, are addressed by the present disclosure.

### SUMMARY

This section provides a general summary of the disclosure and is not a comprehensive disclosure of its full scope or all of its features.

The present disclosure provides a system comprising: a plurality of targets arranged with respect to a testing lane, wherein the plurality of targets are configured as multisensor targets with each target of the plurality of targets having a plurality of calibration elements configured to allow detection by one or more sensors of the vehicle, the plurality of detection elements including one or more elements configured for lidar detection, one or more elements configured for camera detection, and one or more elements configured for radar detection, wherein the testing lane is configured to allow a vehicle to traverse the testing lane between the plurality of targets to detect the plurality of detection elements; and a calibration system configured to: receive detection data from the vehicle as the vehicle traverses the testing lane, the detection data corresponding to lidar detections by the one or more sensors of the vehicle, camera detections by the one or more sensors of the vehicle, and radar detections by the one or more sensors of the vehicle; process the received detection data using a calibration algorithm; and generating one or more calibration parameters for the one or more sensors of the vehicle based on the processing; wherein the calibration system is further configured to use the one or more calibration parameters to generate a valid L3 calibration of the one or more sensors of the vehicle, thereby allowing L3 autonomous operation of the vehicle; wherein a spacing between one or more targets of the plurality of targets is different than a spacing between one or more other targets of the plurality of targets, and an orientation of one or more of the targets of the plurality of targets is different than an orientation one or more other targets of the plurality of targets, the spacing and orientation configured to allow collection of data by the one or more sensors of the vehicle to allow for the valid L3 calibration; wherein one or more targets of the plurality of targets are positioned along a first side of the testing lane and one or more targets of the plurality of targets are positioned on a second side of the testing lane, wherein the first side of the testing lane is on a opposite side to the second side of the testing lane relative to the vehicle traversing between the plurality of targets; wherein the plurality of targets are double sided having a first side and a second side opposite the first side, wherein a first set of calibration elements on the first side is different than a second set of calibration elements on the second side, and wherein the first set of calibration elements are configured for detection by one or more sensors of the vehicle that are forward facing and the second set of calibration elements are configured for detection by one or more sensors of the vehicle that are rearward facing; wherein the one or more elements configured for lidar detection comprise one or more cutouts, the one or more elements configured for camera detection comprise one or more visual tags, and the one or more elements configured for radar detection comprises one or more radar targets as corner reflectors; wherein the one or more cutouts, the one or more visual tags, and the one or more radar targets are arranged on at least one surface of the plurality of targets to allow for collection of detection data by the one or more sensors of the vehicle for L3 calibration; wherein the one or more cutouts are arranged at a center portion of the plurality of targets, the one or more visual tags are arranged along a top portion, the center portion, and a bottom portion of the plurality of targets, and the one or more radar targets are arranged at a bottom portion of the plurality of targets; wherein the one or more cutouts comprise four cutouts arranged in a symmetrical configuration forming an evenly spaced square configuration at a center portion of the plurality of targets, the one or more visual tags comprise sixteen visual tags configured as visual fiducial markers with six of the visual tags arranged in a symmetrical rectangular configuration at a top portion of the plurality of targets, four of the visual tags arranged in a diamond configuration at the center portion of the plurality of targets with a visual tag in a center of the diamond configuration, and five of the visual tags arranged in a U-shaped configuration at a bottom portion of the plurality of targets, each visual tag having a different visual fiducial pattern than the other visual tags, and the one or more radar targets comprise one radar target positioned at the bottom portion of the plurality of targets within the U-shaped configuration of the visual tags; wherein one or more targets of the plurality of targets are movable targets relative to the testing lane and one or more targets of the plurality of targets are fixed targets and non-movable with respect to the testing lane; wherein the calibration system is further configured to process the received detection data using an optimization to estimate a plurality of parameters including a plurality of IMU states at each of a plurality of keyframe timestamps, a plurality of poses of the plurality of targets, and a plurality of extrinsic calibrations; wherein a plurality of constraints are used in the optimization, wherein the plurality of constraints include sensor factors; wherein the calibration algorithm is configured to optimize a non-linear least squares optimization problem using a plurality of cost functions related to 3D-2D reprojection errors from camera target detection, 3D-3D reprojection errors from lidar and radar target detection, 6D-6D errors from sensor odometries, a vehicle kinematic model, and prior information as computer-aided design (CAD) values; and wherein the calibration system is further configured to receive detection data from the vehicle as the vehicle is stopped at a plurality of points along the testing lane, and wherein a location of each of the points and a time period that the vehicle stops at each point of the plurality of points is defined.

The present disclosure provides a method comprising: receiving detection data from a vehicle as the vehicle traverses a testing lane, the detection data corresponding to lidar detections by one or more sensors of the vehicle, camera detections by one or more sensors of the vehicle, and radar detections by one or more sensors of the vehicle, wherein a plurality of targets are arranged with respect to the testing lane, and wherein the plurality of targets are configured as multisensor targets with each target of the plurality of targets having a plurality of calibration elements configured to allow detection by the one or more sensors of the vehicle; processing, by a processor, the received detection data using a calibration algorithm; and generating, by the processor, one or more calibration parameters for the one or more sensors of the vehicle based on the processing; wherein the plurality of detection elements include one or more elements configured for lidar detection, one or more elements configured for camera detection, and one or more elements configured for radar detection, wherein the testing lane is configured allow a vehicle to traverse the testing lane between the plurality of targets to detect the plurality of detection elements; further comprising using the one or more calibration parameters to generate a valid L3 calibration of the one or more sensors of the vehicle, thereby allowing L3 autonomous operation of the vehicle, wherein a spacing between one or more targets of the plurality of targets is different than a spacing between one or more other targets of the plurality of targets, and an orientation of one or more of the targets of the plurality of targets is different than an orientation one or more other targets of the plurality of targets, the spacing and orientation configured to allow collection of data by the one or more sensors of the vehicle to allow for the valid L3 calibration; wherein the plurality of targets are double sided having a first side and a second side opposite the first side, wherein a first set of calibration elements on the first side is different than a second set of calibration elements on the second side, and wherein the first set of calibration elements are configured for detection by one or more sensors of the vehicle that are forward facing and the second set of calibration elements are configured for detection by one or more sensors of the vehicle that are rearward facing; further comprising processing the received detection data using an optimization to estimate a plurality of parameters including a plurality of IMU states at each of a plurality of keyframe timestamps, a plurality of poses of the plurality of targets, and a plurality of extrinsic calibrations, wherein a plurality of constraints are used in the optimization, wherein the plurality of constraints include sensor factors.

The present disclosure provides one or more non-transitory computer-readable media storing processor-executable instructions that, when executed by at least one processor, cause the at least one processor to: receive detection data from a vehicle as the vehicle traverses a testing lane, the detection data corresponding to lidar detections by one or more sensors of the vehicle, camera detections by one or more sensors of the vehicle, and radar detections by one or more sensors of the vehicle, wherein a plurality of targets are arranged with respect to the testing lane, and wherein the plurality of targets are configured as multisensor targets with each target of the plurality of targets having a plurality of calibration elements configured to allow detection by the one or more sensors of the vehicle; process the received detection data using a calibration algorithm; and generate one or more calibration parameters for the one or more sensors of the vehicle based on the processing.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a an EOL calibration station in accordance with one or more embodiments of the present disclosure;

FIG. 2 illustrates a target used for sensor calibration in accordance with one or more embodiments of the present disclosure;

FIG. 3 illustrates a testing lane with targets for sensor calibration in accordance with one or more embodiments of the present disclosure;

FIG. 4 illustrates a vehicle having one or more sensors in accordance with one or more embodiments of the present disclosure;

FIG. 5 is a flow diagram of a calibration process flow in accordance with one or more embodiments of the present disclosure;

FIG. 6 is a block diagram of a calibration system in accordance with one or more embodiments of the present disclosure;

FIGS. 7A and 7B are a diagram illustrating a calibration process flow in accordance with one or more embodiments of the present disclosure;

FIG. 8 is an optimization factor graph in accordance with one or more embodiments of the present disclosure; and

FIG. 9 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide a means for vehicle sensor calibration at a vehicle factory, such as a vehicle assembly facility. For example, an EOL calibration station in accordance with one or more embodiments allows for L3 sensor calibration before a vehicle having autonomous functionality leaves the facility. In one or more examples, the calibration allows for L3 autonomy immediately upon delivery of the vehicle. As such, the vehicles leave the final assembly plant with a valid L3 vehicle sensor calibration, which is valid after transport from the factory to, for example, the customer without the customer having to perform any driving operations to calibrate the L3 autonomy.

System and methods described herein allow for collection of a sufficient amount of data to generate a valid L3 calibration using a calibration system prior to leaving the factory without creating a bottleneck in the final assembly workflow. That is, the calibration process allows for calibrating all vehicle sensors (e.g., cameras, radars, light detection and ranging (lidar), etc.) within a time frame (e.g., within five minutes per stage of calibration) that does bottleneck the process and within an EOL calibration station (e.g., inside a 10mx30m indoor calibration cell).

In general, vehicle calibration is performed to maintain accurate sensor extrinsic and intrinsic calibrations for the vehicle, including time varying Inertial Measurement Unit (IMU) intrinsics. The latter is provided by downstream modules, such as using Vehicle State Estimation (VSE). L3 sensor calibration in one or more embodiments maintains sensor calibration for a combination of cameras, radar, lidar, IMU, and wheel speed sensors (WSS) with L3 sensor calibrations generated prior to the vehicle leaving the final assembly plant. As a result, the vehicles are able to operate with L3 autonomy immediately upon leaving the factory. Thus, with the herein described one or more embodiments of factory sensor calibration, the vehicles do not have to be driven by the customer after delivery in order to be able to engage L3 autonomy, thereby enhancing the user experience. For example, instead of using online calibration where the dealership or the customer drives the vehicle for several days before the sensors are calibrated for L3 autonomous operation, one or more herein described embodiments allow for autonomous engagement upon delivery of the vehicle without the extra driving calibration.

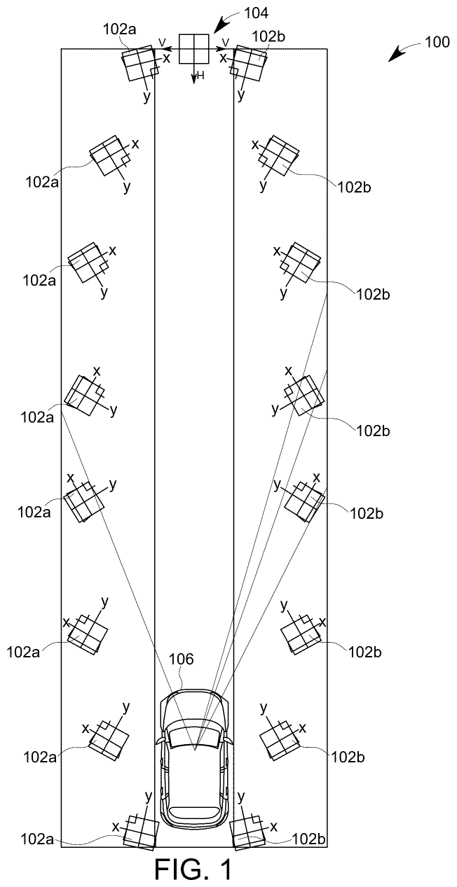

Referring to FIG. 1, an EOL calibration station 100 is shown that allows for vehicle sensor calibration in accordance with one or more embodiments that includes a plurality of targets 102. As can be seen, the plurality of targets 102 are positioned along sides of a testing lane 104 through which a vehicle 106 travels or traverses. That is, the plurality of targets 102 are arranged to allow calibration of one or more sensors of the vehicle 106 as the vehicle 106 moves along the testing lane 104 between the plurality of targets 102. For example, the EOL calibration station 100 is configured as a factory calibration cell for use in calibrating one or more sensors of the vehicle 106. The configuration of the EOL calibration station 100, such as the length of the testing lane 104, the number of targets 102, the positioning, spacing, and orientation of the plurality of targets 102, etc. can be varied as desired or needed. For example, based on the type of the vehicle 106, the sensors to be tested, etc., the configuration of the components forming the EOL calibration station 100 can be varied.

In one or more embodiments, such as shown in FIG. 1, the EOL calibration station 100 includes eight targets 102a (e.g., double sided targets) spaced apart along one side of the testing lane 104 (e.g., a 10 meter by 30 meter testing lane) and eight targets 102b spaced apart along an opposite side of the testing lane 104. As can be seen, in the illustrated configuration, the spacing between the targets 102, the orientation of the targets 102 (e.g., the angle of the targets 102 relative to the testing lane), and the distance of the target 102 from the side of the testing lane 104 is varied along the testing lane 104 (e.g. optimized for collection of sensor calibration data for L3 validation). That is, one or more of the targets 102 have a different relative positioning, orientation, etc. to one or more other targets 102. For example, the plurality of targets 102 on each side of the testing lane 104 are arranged to allow for acquiring sensor calibration data for providing L3 autonomous operation capabilities of the vehicle 106 upon exit from the manufacturing facility (e.g., after being calibrated by the EOL calibration station 100). The arrangement of the plurality of targets 102 as well as the configuration of the elements on the plurality of targets 102 as described in more detail herein allows for acquiring data based on detections by different sensors of the vehicle 106 (e.g., lidar detection(s), camera detection(s), radar detection(s), etc.).

In one or more embodiments, some of the plurality of targets 102 are arranged in a movable configuration and some of the plurality of targets 102 are arranged in a fixed configuration. However, as should be appreciated, different targets of the plurality of targets 102 can be fixed in position or capable of movement. In some embodiments, all of the plurality of targets 102 are fixed (e.g., non-movable) or all of the plurality of targets 102 are movable (e.g., configured having wheels to allow separate movement of each of the targets 102 or movable using robotic arms). As an example, the plurality of targets 102 can be configured (e.g., positioned, oriented, etc.) for acquisition of different sensor data, such as having one or more of the targets 102 configured as camera intrinsics targets that can be moved in order to cover the field of view of different cameras, and one or more targets 102 configured as calibration targets that are static and designed to be sensed by camera, lidar and radar sensors. As should be appreciated, the plurality of targets 102 are positioned, for example, in various orientations to not have singularities and the positions do not have to be manually surveyed, but the internal structures are assumed to be known. It should be noted that an external measurement system to define target positions in one or more embodiments is only considered as a backup option in the event that onboard options cannot sufficiently provide all objectives.

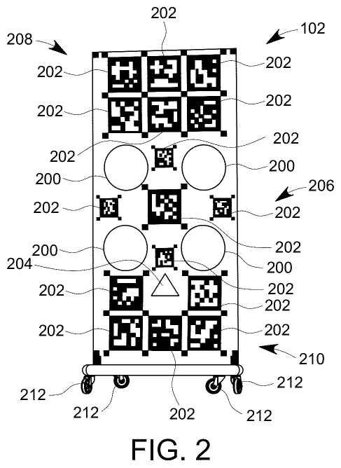

In one or more embodiments, the plurality of targets 102 are configured as shown in FIG. 2. That is, in the illustrated example, each target 102 includes the same calibration elements (e.g., same set of calibration elements) as described in more detail below. However, different configuration are also contemplated. In some embodiments, one or more of the plurality of targets 102 is double-sided (having opposing first and second surfaces) and includes the same or different calibration elements on both sides of the target 102. As such, forward and rearward facing sensors of the vehicle 106 detect the same calibration elements on different sides of the targets 102 as the vehicle moves towards and then passes each of the targets 102. However, as should be appreciated, one or more of the targets 102 can have the calibration elements on only one side, such as a front side or a back side of the target 102 as viewed by the vehicle 106. As should further be appreciated, one or more of the targets 102 can have different calibration elements on each side of the target 102, for example, a different set, number, type, configuration, relative location, etc. of calibration elements on each side of the target 102. That is, a first set of calibration elements on a first side of targets 102 is different than a second set of calibration elements on a second side of the targets 102.

In various embodiments, the calibration elements includes one or more cutouts 200, one or more visual tags 202, and one or more radar targets 204 (e.g., radar target(s) as corner reflector(s)). In the illustrated example, the target 102 includes four cutouts 200, sixteen visual tags 202, and one radar target 204. As can be seen, the four cutouts 200 (illustrated as spherical openings through the board of the target 102) are arranged in a symmetrical configuration at a center portion 206 of the target. That is, the cutouts 200 are evenly spaced apart in a square configuration and configured to allow lidar detections by one or more lidar sensors of the vehicle 106 as the vehicle 106 travels along the testing lane 104. It should be noted that the cutouts 200 can have different shapes, different sizes, different relative positions, etc. than shown. The cutouts 200 in one or more embodiments are spherical radar targets that constrain radar-to-radar, lidar-to-lidar and radar-to-lidar extrinsics.

The sixteen visual tags 202, which are configured as visual fiducial tags (e.g. April Tags), are arranged in different patterns along the target 204. For example, six of the visual tags 202 are arranged in a symmetrical rectangular configuration at a top portion 208 of the target, four visual tags 202 (smaller that all of the other visual tags 202, which are the same size) are arranged in a diamond configuration (positioned between the cutouts 200) at the center portion 206 of the target 102 with a visual tag 202 in a center of the diamond configuration, and five of the visual tags 202 are arranged in a U-shaped configuration a bottom portion 210 of the target 102, with each visual tag 202 having a different visual fiducial pattern than the other visual tags 202. The visual tags 202 are configured to allow camera detections by one or more camera sensors of the vehicle 106 as the vehicle 106 travels along the testing lane 104.

The one radar target 204 is positioned at the bottom portion 210 of the target 102 within the U-shaped configuration of the visual tags 202. The radar target 204 is configured to allow radar detections by one or more radar sensors of the vehicle 106 as the vehicle 106 travels along the testing lane 104.

It should be appreciated that the illustrated calibration elements including the one or more cutouts 200, one or more visual tags 202, and one or more radar targets 204 is shown merely for illustration of one overall configuration for the target 102. Different numbers, arrangements, positioning, sizes, shapes, types, patterns, etc. of the calibration elements can be used to perform sensor calibration as described in more detail herein. That is, the calibration elements of the target 102 can be modified as desired or needed, such as based on the type of calibration, the type of vehicle, etc.

In the illustrated example, the target 102 is movable. That is, the target 102 includes wheels 212 at the bottom portion 210 of the target 102 to facilitate moving the target 102 to different locations, orientations, etc. along the testing lane 104.

Thus, in one or more embodiments, the plurality of targets 102 are multisensor targets detectable in camera, lidar and radar data and constrain the extrinsics between all three sensor modalities. For example, the visual tags 202 are detectable by cameras and constrain camera-to-camera extrinsics. It should be noted that target detection as described in more detail herein can receive as input a sensor image or point cloud and output the location of target coordinates in the sensor frame.

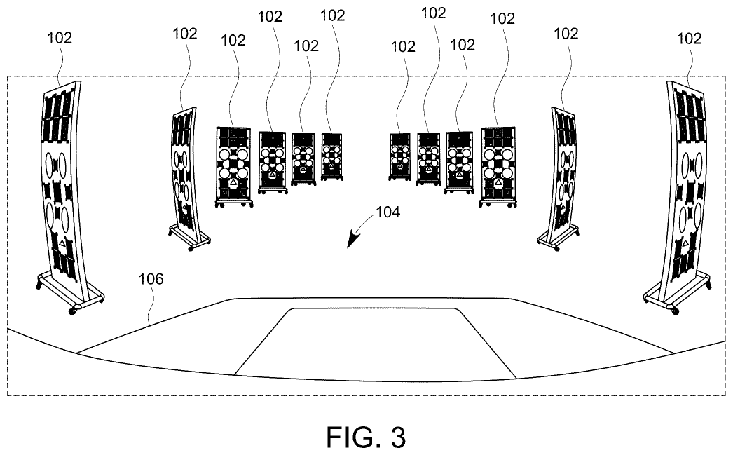

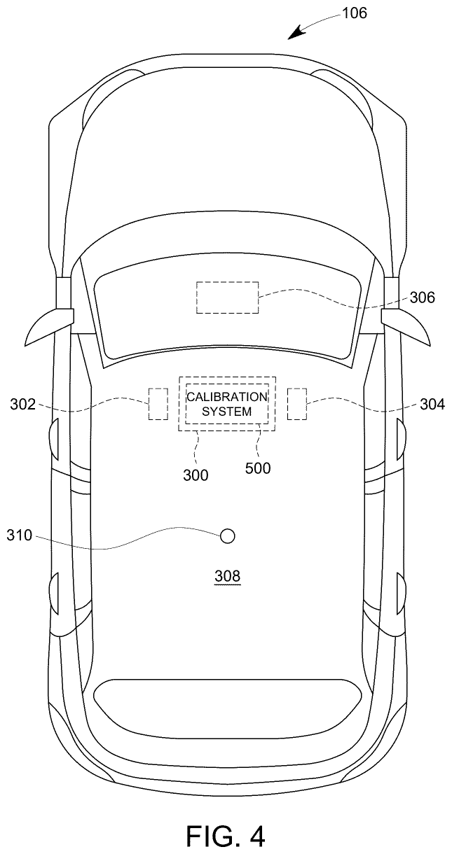

In operation to perform calibration of the sensors of the vehicle 106, the vehicle 106 moves on the vehicle's wheels at slow speed and stops and starts at different points along the testing lane 104 in order to excite the IMU. That is, the vehicle 106 moves along the testing lane 104 (FIG. 3 illustrates the vehicle 106 on the testing lane 104) to allow acquisition of detection data by the various sensors of the vehicle 106. For example, as shown in FIG. 4, the vehicle(s) 106 may be powered in a variety of ways, for example, with an electric motor and/or an internal combustion engine. It is understood that the vehicle(s) 106 may be any type of vehicle powered by an electric motor and/or an internal combustion engine such as a car, a truck, a robot, a plane, a train, and/or a boat. The vehicle(s) 106 generally include a vehicle controller 300, one or more actuators 302, a plurality of on-board sensors 304, a human machine interface (HMI) 306, and a vehicle system 308. The vehicle(s) 106 also has a reference point 310, that is, a specified point within a space defined by a vehicle body that identifies the location of the vehicle(s) 106. For example, the reference point 310 is a geometrical center point at which respective longitudinal and lateral center axes of the vehicle(s) 106 intersects. As another example, the reference point 310 is a point at which the vehicle(s) 106 is located as the vehicle(s) 106 navigates along the testing lane 104.

The vehicle controller 300, in some examples, is configured or programmed to control the operation of one or more of vehicle brakes, propulsion (e.g., control of acceleration in the vehicle(s) 106 by controlling one or more of an internal combustion engine, electric motor, hybrid engine, etc.), steering, climate control, interior and/or exterior lights, etc. The vehicle controller 300, in other examples, is further configured or programed to determine whether and when the vehicle controller 300, as opposed to a human operator, is to control such operations related to the vehicle(s) 106. It is understood that any of the operations associated with the vehicle(s) 106 may be facilitated via an automated, a semi-automated, or a manual mode. For example, the automated mode may facilitate any of the operations to be fully controlled by the vehicle controller 300 without the aid of the human operator. As another example, the semi-automated mode (e.g., L3 autonomy) may facilitate any of the operations to be at least partially controlled by the human operator in combination with the vehicle controller 300. As a further example, the manual mode may facilitate the operations to be fully controlled by the human operator without the aid of the vehicle controller 300.

The vehicle controller 300 includes, or may be communicatively coupled to (e.g., via a vehicle communications bus), one or more processors (not shown). For example, the one or more processors can be a controller, or the like, included in the vehicle(s) 106 for monitoring and/or controlling various vehicle controllers, such as a powertrain controller, a brake controller, a steering controller, etc. The vehicle controller 300 is generally arranged for communications on a vehicle communication network (not shown) that can include a bus in the vehicle(s) 106, such as a controller area network (CAN), or the like, and/or other wired and/or wireless mechanisms.

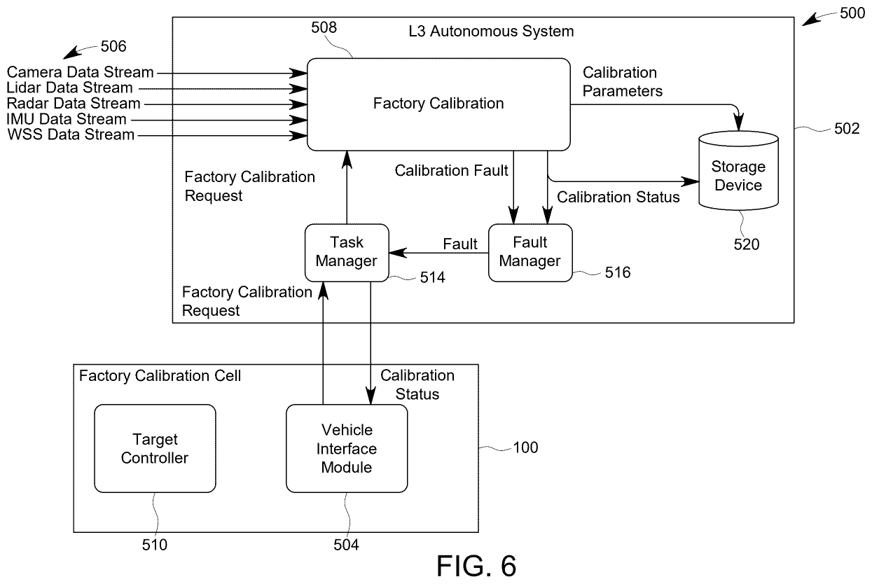

In one or more embodiments, via a vehicle network, the vehicle controller 300 transmits messages to various devices in the vehicle(s) 106 and/or receives messages from the various devices, for example, the one or more actuators 302, the HMI 306, etc. Alternatively, or additionally, in cases where the vehicle controller 300 includes multiple devices, the vehicle communication network is utilized for communications between devices represented as the vehicle controller 300 in this disclosure. Further, as discussed below, various other controllers and/or sensors provide data to the vehicle controller 300 via the vehicle communication network, which can then be provided to a calibration system 500 (see also FIG. 6) for use in sensor calibration as described in more detail herein. For example, the vehicle controller 300 is configured for communicating using a vehicle-to-infrastructure communication network, such as communicating with an infrastructure controller (not shown) to allow communication of sensor detection data to the calibration system 500. The vehicle controller 300 can also be configured, for example, for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 300 of the vehicle(s) 106 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 302 are implemented via circuits, chips, or other electronic and/or mechanical components that can actuate various vehicle subsystems in accordance with appropriate control signals. The one or more actuators 302 may be used to control braking, acceleration, and/or steering of the vehicle(s) 106. The vehicle controller 300 can be programmed to activate the one or more actuators 302 including propulsion, steering, and/or braking based on the planned acceleration or deceleration of the vehicle(s) 106.

The plurality of on-board sensors 304 include a variety of devices to provide data to the vehicle controller 300 and/or to the calibration system 500 as described in more detail herein. For example, the plurality of on-board sensors 304 may include object detection sensors (e.g., lidar sensor(s)) disposed on or in the vehicle(s) 106) that provide relative locations, sizes, and/or shapes of one or more objects surrounding the vehicle(s) 106, such as additional vehicles, bicycles, robots, drones, etc., and/or the targets 102, positioned or travelling next to, ahead, and/or behind the vehicle(s) 106. As another example, one or more of the plurality of on-board sensors 304 can be radar sensors affixed to one or more bumpers of the vehicle(s) 106 that may provide locations of the object(s) relative to the location of each of the vehicles 106.

The plurality of on-board sensors 304 may include a camera sensor, for example, to provide a front view, side view, rear view, etc., providing images from an area surrounding the vehicle(s) 106. As another example, the vehicle controller 300 may be programmed to receive sensor data from a camera sensor(s) and to implement image processing techniques to detect a road, infrastructure elements, etc. The vehicle controller 300 may be further programmed to determine a current vehicle location based on location coordinates (e.g., GPS coordinates) received from the vehicle(s) 106 indicative of a location of the vehicle 106 determined from a GPS sensor (not shown).

The HMI 306 is configured to receive information from the human operator during operation of the vehicle(s) 106. Moreover, the HMI 306 is configured to present information to the human operator, such as, an occupant of the vehicle(s) 106. In some examples, the vehicle controller 300 is programmed to receive destination data (e.g., location coordinates) from the HMI 306.

The vehicle system 308 is configured to control each of the subsystems within the vehicle(s) 106 and facilitate requests across each of the above-described components (e.g., the vehicle controller 300, the one or more actuators 302, the plurality of on-board sensors 304, and/or the HMI 306). Accordingly, the vehicle(s) 106 can be autonomously guided (or perform other L3 autonomy functions or operations) using at least the plurality of on-board sensors 304.

In one or more examples, the movement of the vehicle 106 (e.g., stops and starts of the vehicle), as well as the calibration process as described in more detail herein, is designed to be tolerant to the variations in trajectory parameters, such as curvature or driving speed, due to manual operation. In some examples, the calibration process is prescriptive with respect to how the vehicle 106 is to be driven along the testing lane 104. In one or more embodiments, markers on the floor of the testing lane 104 can be used to signal stop and go locations, however other indicators may be used, such as external signaling or an interface inside the car, such as depending on the tests to be performed.

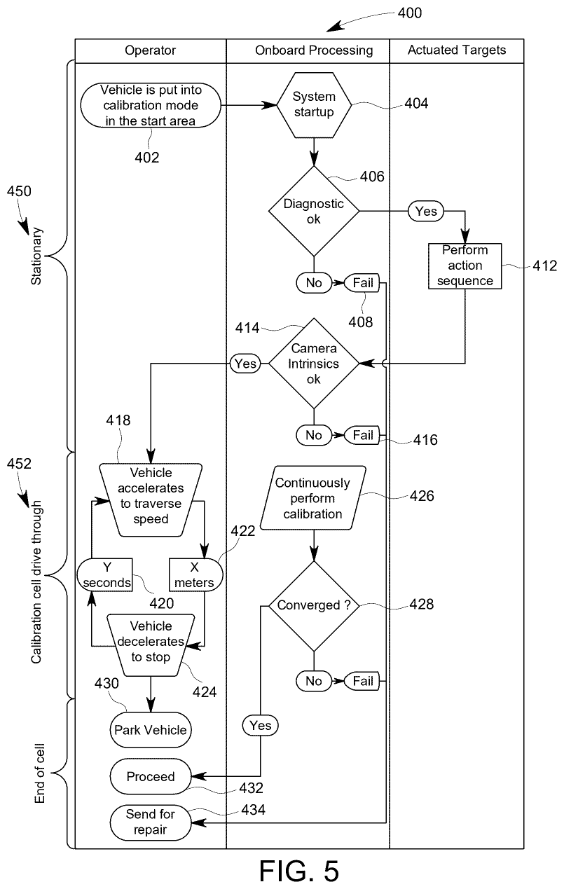

In one or more embodiments, the calibration process performed using the EOL calibration station 100 allows for separate stages as part of a process flow 400 shown in FIG. 5, as follows:

1. Stationary stage 450—initializes IMU calibration and validates camera intrinsics, which affects one or more of the following parameters: IMU roll, pitch; and IMU biases.

2. Calibration cell drive through stage 452—estimates all sensor extrinsic transforms and estimates IMU-to-vehicle calibration, which affects one or more of the following parameters: sensor transforms; IMU roll, pitch, yaw; and IMU biases.

3. Maneuvering stage—enhances IMU calibration in this optional stage, which affects one or more of the following parameters: IMU roll, pitch, yaw; IMU X,Y,Z; and IMU biases.

In one or more embodiments, as illustrated in the process flow 400, calibration of one or more camera sensors can be performed. It should be appreciated that the various embodiments allow for performing all calibration activities for the vehicle 106 and the description of camera sensor calibration is an example of one type of calibration. For example, one or more embodiments allow for sensor calibration to be performed that allows for normal operation of the L3 system and supports a drive off the lot scenario wherein the vehicle driver can engage L3 operation upon initial operation of the vehicle 106 without requiring additional driving. In various embodiments, the sensor intrinsic values are also validated to address any constraints of the L3 system.

Using the process flow 400, values for calibration variables are determined that minimize cost functions associated with different variables. For example, in various embodiments different factory calibration cost functions are used for the different sensor detections, as follows:

$$3 D detections cost function ( LIDAR , RADAR )$$

$${\sum }_{i = 0}^{board \_ det} {\sum }_{j = 0}^{num \_ pts} {( {T}_{{board}_{k}}^{W} {t}_{{k}_{j}} - {T}_{{imu}_{t}}^{W} {T}_{sensor}^{{imu}_{t}} {t}_{{i}_{{j}_{t}}} )}^{2}$$

$$2 d image detections cost function ( Camera )$$

$$\text{?} {\sum }_{j = 0}^{4} {( {u}_{ij} - reproj ( {T}_{imu}^{camera} {T}_{W}^{imu} \text{?} ) )}^{2}$$

$$Relative motion cost function ( Lidar Odometry )$$

$${\sum }_{i = 0}^{num \_ motions} {( log ( {( \text{?} )}^{- 1} {T}_{sensor}^{imu} {T}_{{sensor}_{j}}^{{sensor}_{i}} {T}_{imu}^{sensor} ) )}^{2}$$

$$\text{?} \text{indicates text missing or illegible when filed}$$

In one or more examples, vehicle poses and landmarks are expressed in a gravity aligned inertial frame, W. The origin of the inertial frame does not have an affect on the outcome and is selected to be the initial position of the vehicle 106.

The vehicle state at time t is xv t and consists of:
Vehicle pose∈SE(3) in W;
Velocity of the vehicle frame, relative to W, resolved in the vehicle frame and angular rate; and
Time varying IMU accelerometer and gyro biases.

Sensor transforms are indicated with T v s∈SE(3) and transforms vectors from sensor frame s to the vehicle frame v. s∈{r, L, c, I} and stand for radar, lidar, camera and IMU respectively.

In the stationary stage 450, camera intrinsics are validated using the plurality of targets 102. That is, the plurality of targets 102 are presented to each of the cameras of the vehicle 106 at different poses while the vehicle 106 is stationary. It should be noted that the poses of the plurality of targets 102 are arranged to encompass the field of view of the cameras (e.g., a wide forward camera field of view and a narrow forward camera field of view as shown in FIG. 1) and be stationary at each pose before moving to the next one. As such, stationary IMU calibration is also performed.

More particularly, an operator starts the process by placing the vehicle 106 into a calibration mode at 402, which results in a vehicle onboard processing initiating a system startup at 404. A determination is made at 406 whether diagnostics are operating correctly. If diagnostics are not operating correctly, then a fail is indicated at 408. If diagnostics are operating correctly (normal operation), then the vehicle 106 is parked into a start area, for example, at the start of the testing lane 104. An action sequence is then performed at 412 using actuated targets, for example, one or more targets 102 in the field of view of the cameras of the vehicle 106.

A determination is then made at 414 whether camera intrinsics are operating correctly (normal operation). If camera intrinsics are not operating correctly, then a fail is indicated at 416. If intrinsics are operating correctly (normal operation), then the vehicle 106 accelerates to a traverse speed at 418, which is part of the calibration cell drive through stage 452. In this calibration cell drive through stage 452, the vehicle 106 moves through the EOL calibration station 100 with calibration performed for all sensors using the plurality of targets 102. During movement of the vehicle 106, which may include multiple stops (the vehicle 106 decelerates to a stop at 424 and is parked at 430) and starts at a defined time period (e.g., Y seconds) at 420 and/or a defined distance at 422 (X meters) as described in more detail herein. The number of targets 102 and samples detected from the sensors is thereby increased, which allows for the creation of an association between sensors from the detections of the same target 102 as described in more detail herein. IMU excitations are also generated, which allows for observing IMU to vehicle yaw angle, as well as other rotation parameters as described in more detail herein. That is, onboard processing of the vehicle 106 continuously processes and records data at 426 for use in sensor calibration as described in more detail herein.

In particular, sensor detection data is processed until a determination is made at 428 that the data values have converged using the cost functions. In one or more embodiments, a vehicle kinematic model is used to solve sensor to vehicle transform estimations. Optimization may then be performed, for example using an optimizer that constructs a non-linear least squares optimization problem and solves the problem with the Levenberg-Marquardt (LM) algorithm. In some embodiments, the construction of the non-linear least squares optimization problem employs one or more of the following cost functions: three-dimensional to two-dimensional (3D-2D) reprojection errors from camera target detection, 3D-3D reprojection errors from lidar and radar target detection, 6D-6D errors from sensor odometries (e.g., 6D-6D errors for relative motion), a vehicle kinematic model, and prior information as CAD values. The optimization in one or more embodiments results in a set of metrics that can be used as described herein, including metrics related to byproducts of the optimization process and sensor extrinsics.

In one or more embodiments, the sensor data is subsampled as the vehicle 106 moves through the EOL calibration station 100. As described in more detail herein, a keyframe is used to denote a point in time that the sensor data will be sampled. Keyframing is triggered in some embodiments when the vehicle 106 stops, or is detected to have translated a threshold distance. In one or more embodiments, time can be used for keyframe triggering. This threshold in various examples is determined as a tradeoff between simplifying the optimization process while not compromising the results.

In response to the data values converging, the vehicle 106 is able to proceed at 432, for example to another cell within the factory. If a determination is made at 428 that the values do not converge, in one or more embodiments, the vehicle is sent for repair (e.g., replace one or more sensors) at 434. In some embodiments, if a determination is made that the values do not converge, the vehicle 106 optionally can enter a maneuvering track stage wherein the vehicle performs additional motion sequences. The maneuvering track stage enhances IMU calibration and enhances yaw rate bias estimations. In some embodiments, one or more maneuvers are performed by the vehicle 106 outside of the EOL calibration station 100 and without use of the targets 102.

Thus, in one or more embodiments, the process flow 400 provides a factory calibration of vehicle sensors at a final assembly plant, such as after vehicle assembly and before a final drive. For example, the EOL calibration station 100 is configured as a calibration cell to calibrate camera, radar, lidar, and IMU extrinsics, as well as calibrate and/or validate camera and lidar intrinsics (provided by the supplier) by performing the process flow 400. That is, the process flow 400 allows for initially validating sensor intrinsics while the vehicle 106 is stationary. In the stationary stage 450, specialized intrinsic target boards, namely the plurality of targets 102 are positioned at various locations to cover the field of view of all cameras. It should be noted that depending on the effect of the windshield on the front camera, some intrinsics may have to be re-estimated. During the stationary stage 450, the IMU pitch, roll and bias levels are also captured in one or more embodiments. For example, the stationary stage 450 is performed at the beginning of the testing lane 104 and is used for estimating the initial IMU biases and computing the IMU rotation relative to gravity.

As described in more detail herein, the stationary stage 450 is followed by manually driving the vehicle 106 on a trajectory (e.g., along a nominally straight trajectory and/or along one or more curved trajectories) through the rest of the EOL calibration station 100. The EOL calibration station 100 includes the plurality of targets 102 configured as multi-sensor targets. That is, the targets 102 are configured to be detected by all vision sensors: camera, lidar, and radar. It should be noted that the vehicle 106 is manually driven by a trained human operator in some embodiments. It should also be noted that the process is configured to tolerate inconsistencies from natural driving and does not require strict straightness of the trajectory. The operator will occasionally (e.g., periodically) stop the vehicle 106 as described in more detail herein. The locations and durations of the stops are defined, but are not strictly constrained in order to be robust against manual driving.

The process flow 400 in various embodiments allows for one or more of:
Generating new sensor calibration parameters before the vehicle 106 leaves the factory;
Evaluating sensor calibration quality before the vehicle 106 leaves the factory;
Storing sensor calibration parameters;
Providing sensor calibration parameters; and
Providing sensor calibration status, including reporting failures in the calibration process before the vehicle 106 leaves the factory with the failure reports providing details for the factory to take action to resolve the issue (e.g. via repair).

Thus, with the vehicle 106 assembled, one or more embodiments initiate a factory calibration and collect intrinsic data while the vehicle 106 traverses the EOL calibration station 100. The intrinsic data is then processed, which results in the vehicle 106 being able to proceed (calibration pass) or the vehicle 106 being sent for repair (calibration fail).

An example of the calibration system 500 is shown in FIG. 6. The calibration system 500 includes an L3 system 502 that is communicatively coupled to the EOL calibration station 100 configured as a factory calibration cell. As can be seen, the L3 system 500 communicates with a vehicle interface module 504, which may be embodied as or form part of the vehicle controller 300. The L3 system 500 is configured to receive calibration data as a plurality of inputs 506. For example, a plurality of data streams corresponding to sensor detections are received by the L3 system 502, which may include, without limitation, a camera data stream corresponding to data received from one or more camera sensors of the vehicle 106, a lidar data stream corresponding to data received from one or more lidar sensors of the vehicle 106, a radar data stream corresponding to data received from one or more radar sensors of the vehicle 106, an IMU data stream corresponding to data received from one or more sensors of the vehicle 106, and wheel speed sensor (WSS) data corresponding to data received from one or more sensors of the vehicle 106. In one or more embodiments, the plurality of inputs 506 are data from a standard autonomy sensor pipeline.

A factory calibration processor 508 of the calibration system 500 processes the plurality of inputs 506 using a calibration algorithm configured to perform sensor calibration as described in more detail herein. For example, the calibration algorithm processes the plurality of inputs 506 to generate calibration parameters that are communicated to a calibration monitor of the factory calibration processor 508. The factory calibration processor 508 is also configured to output the calibration parameters and calibration status data to a fault manager 516 and a storage device 520. The factory calibration processor 508 also communicates any calibration faults to the fault manager 516, which may support, for example to a SAD system in one or more embodiments. The fault manager 516 communicates fault(s) to a task manager 514 that also receives factory calibration requests from the vehicle interface module 504, such as to initiate a sensor calibration as described in more detail herein. It should be noted that calibration faults communicated to the task manager 514 via the fault manager 516 may be to address fault issues as described herein.

In operation, in one or more embodiments, the calibration algorithm of the factory calibration processor 508 constructs a batch optimization problem using constraints from detections of the targets 102 (using a target controller 510 in one or more embodiments) in the EOL calibration station 100 and sensor odometries. It should be noted that the sensor odometries constrain sensor transformations between keyframes. IMU preintegration constraints are also used to calibrate IMU related parameters in the EOL calibration station 100.

The calibration algorithm of the factory calibration processor 508 is configured to solve for the following unknowns and intrinsics:
1. Vehicle-sensor extrinsics for all cameras, lidars, radars and IMU;
2. Vehicle poses in the worldframe at each keyframe; and
3. Target poses in the worldframe.

In some embodiments, the sensor data is subsampled as the vehicle 106 moves through the EOL calibration station 100. It should be noted that a keyframe denotes a point in time that the sensor data will be sampled. Keyframing is triggered when the vehicle 106 stops, or is detected to have translated a threshold distance as described herein. It should also be noted that target detection in one or more embodiments receives as an input a sensor image or point cloud and outputs the location of target coordinates in the sensor frame.

In operation, the calibration algorithm in some embodiments uses a bundle adjustment to refine target CAD values. The calibration algorithm also constructs the optimization problem to estimate the target positions and the position of the camera(s) or other sensors at each keyframe.

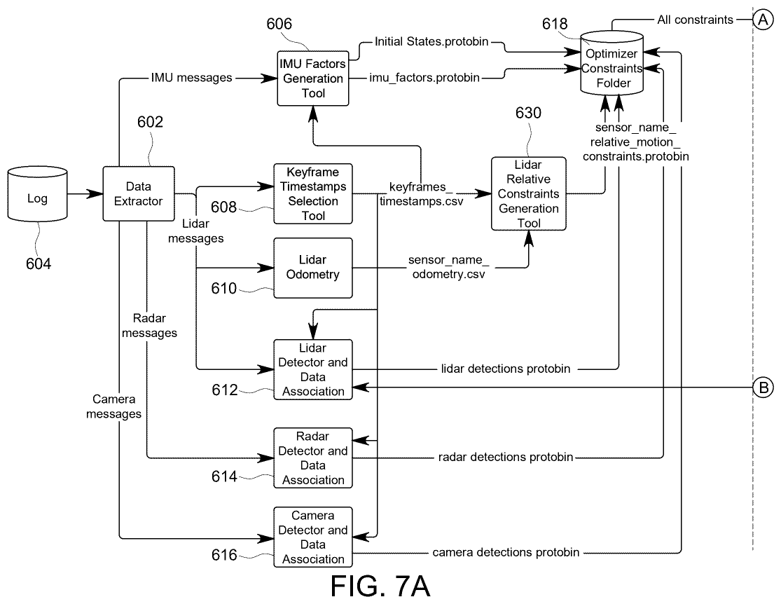

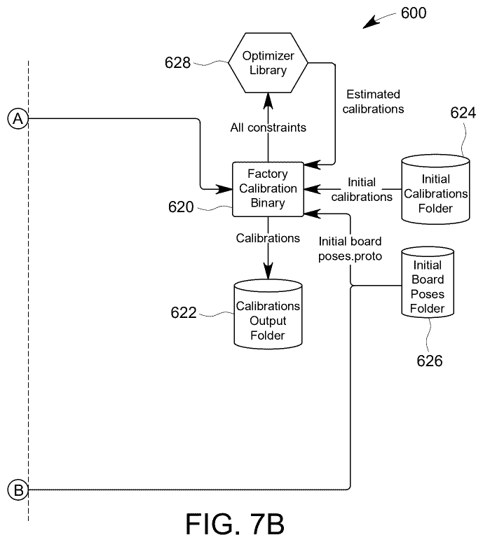

FIGS. 7A and 7B illustrates a factory calibration process flow 600 in accordance with one or more embodiments. The factory calibration process flow 600 can be performed, for example, on an on-board system (e.g., the calibration system 500). However, portions of the processing can be performed using other systems, including on-board the vehicle 106. In the factory calibration process flow 600, a data extractor 602 extracts data for calibration from a log 604. For example, sensor detection data acquired while the vehicle 106 traverses the EOL calibration station 100 is logged and used by the factory calibration process flow 600.

The data extractor 602 is configured to extract data corresponding to the different sensors of the vehicle 106 and generate messages. For example, IMU messages are generated based on extracted IMU detection data and transmitted to an IMU factors correction tool 606. Lidar messages are generated based on extracted lidar detection data and transmitted to a keyframe timestamps tool 608, a lidar odometry component 610 and a lidar detector and data association component 612. Radar messages are generated based on extracted radar detection data and transmitted to a radar detector and data association component 614. Camera messages are generated based on extracted camera detection data and transmitted to a camera detections and data associations component 616.

The IMU factors correction tool 606 generates initial states data and IMU factors data, which are transmitted to an optimizer constraints folder component 618. Additionally, keyframe timestamps data generated by the keyframe timestamps tool 608 and sensor odometry data from the lidar odometry component 610 are transmitted to a lidar relative constraints generation tool 630, which generates sensor relative motion constraints data that is transmitted to the optimizer constraints folder component 618. The lidar detector and data association component 612 generates lidar detection data that is transmitted to the optimizer constraints folder component 618, the radar detector and data association component 614 generates radar detections data that is transmitted to the optimizer constraints folder component 618, and the camera detections and data associations component 616 generates camara detections data that is transmitted to the optimizer constraints folder component 618.

All of the constraints associated with the extracted sensor data is transmitted from the optimizer constraints folder component 618 to a factory calibration binary 620. The factory calibration binary 620 evaluates the reliability of a binary classifier's probabilistic predictions and generates calibration data that is output to a calibrations output folder storage device 622. The factory calibration binary 620 also receives as inputs initial calibration data from an initial calibration folder storage device 624 and initial board pose data (related to an initial pose of the targets 102) from an initial board poses folder storage device 626. The factory calibration binary 620 outputs all constraints to an optimizer library 628 that generates estimated calibrations based on one or more optimizations as described in more detail herein and transmits the estimated calibrations back to the factory calibration binary 620 to update the probabilistic predictions of the factory calibration binary 620.

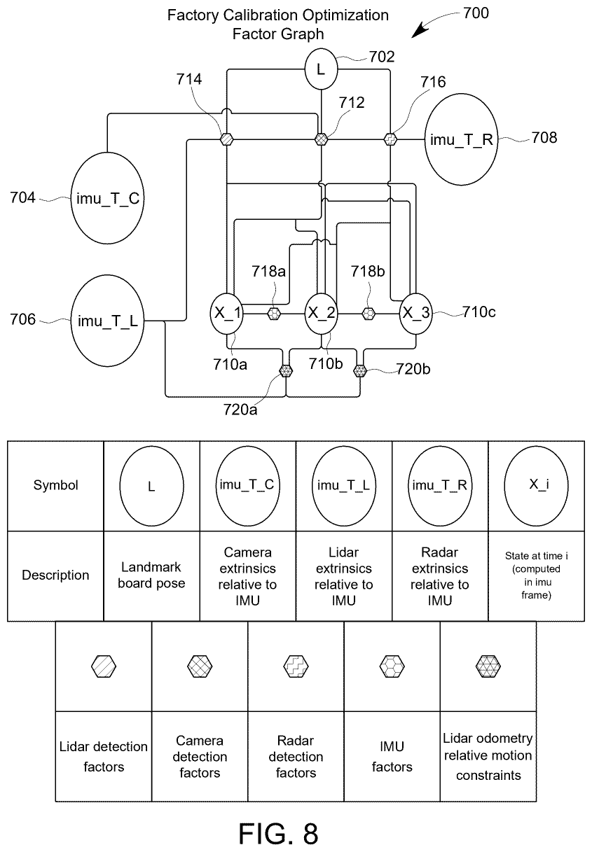

One or more optimizations are performed in one or more embodiments by implementing a factory calibration optimization factor graph 700 as illustrated in FIG. 8. The factory calibration optimization factor graph 700 is a bipartite graph representing the factorization of a function, which in one or more embodiments is an optimization, for example an optimization function used to calibrate the sensors of the vehicle 106. The factory calibration optimization factor graph 700 represents factorization of a probability distribution function that allows for the computation of marginal distributions through the sum-product algorithm in various embodiments.

In operation, the factory calibration optimization factor graph 700 in one or more embodiments estimates the following parameters:
IMU States (at each keyframe timestamp)—Position, Rotation, Velocity, Gyro bias, Accelerometer bias;
Board Poses (6DOF) for n boards; and
   Extrinsic calibrations—imu_SE3_camera (x8), imu_SE3_lidar (x2), imu_SE3_radar (x5).

The factory calibration optimization factor graph 700 uses the following constraints in the optimization: lidar detection factors; radar detection factors; camera detection factors; IMU preintegration factors; and lidar odometry relative motion factors. It should be appreciated that any sensor factors may be used and the above is merely for example.

More particularly, in the factory calibration optimization factor graph 700, landmark board pose data 702 is used with camera extrinsics relative to IMU data 704 to determine camera detection factors 712. Lidar extrinsics relative to IMU data 706 is used with state information 710a at a first time to determine lidar detection factors 714. Radar extrinsics relative to IMU data 708 is used with state information 710c at a third time to determine radar detection factors 716. State information 710a, 710b, 710c at first, second and third times are used to determine IMU factors 718a, 718b. State information 710a, 710b, 710c at first, second and third times is used with lidar extrinsics relative to IMU data 706 to determine lidar odometry relative motion constraints 720a, 720b. As should be appreciated, the factory calibration optimization factor graph 700 utilizes different combinations as shown and the above is merely an example of some of the constraints uses to estimate parameters in the optimization.

Thus, one or more embodiments provide vehicle sensor calibration at a factory that allows for L3 operation of the vehicle 106 without additional calibration after leaving the factory.

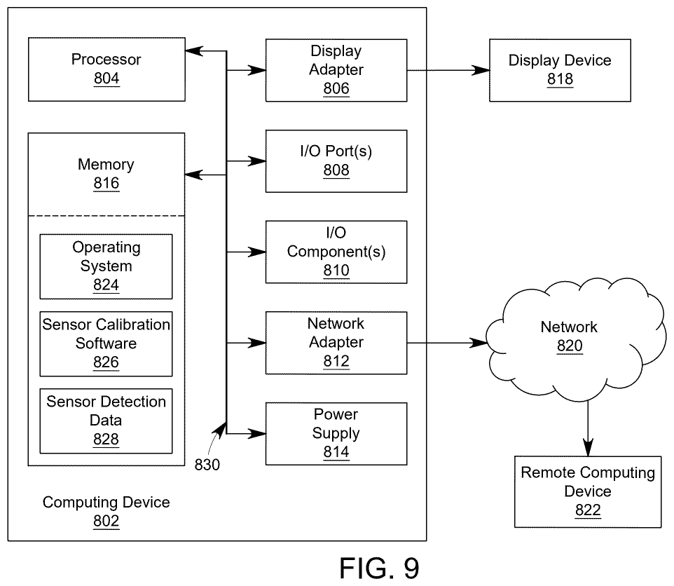

FIG. 9 illustrates an operating environment that facilitates the performance of one or more systems and methods described herein. More specifically, the systems and methods described herein can be implemented using a computing device 802. For example, the computing device 802 can be a personal computer, a desktop, a laptop, a tablet, a hand-held computer, a server, a workstation, a mainframe, a wearable computer, a supercomputer, or a combination thereof. However, it is understood that the aforementioned examples of the computing device 802 is non-exhaustive and the computing device 802 can be any type of processing or computing device. The computing device 802 generally includes a processor 804, a display adapter 806, one or more input/output port(s) 808, one or more input/output component(s) 810, a network adapter 812, a power supply 814, and a memory 816. However, it is understood that the computing device 802 can include any additional components therein and is not required to include any of the listed components (e.g., the processor 804, the display adapter 806, the one or more input/output port(s) 808, the one or more input/output component(s) 810, the network adapter 812, the power supply 814, and the memory 816).

The processor 804 is configured to provide instructions to the computing device 802 so that the computing device 802 can process one or more tasks including the implementation of a software program to perform one or more operations as described in more detail herein. It is also understood that the computing device 802 may include any number or processors 804 therein. The display adapter 806 can be a graphics card or a video board that provides the computing device 802 with a capability to display content on a display device 818. For example, the display device 818 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 818 is non-exhaustive and that the display device 818 can be any type of device capable of providing a visual display.

The input/output port(s) 808 provide a number of interfaces (e.g., sockets) for one or more cables to connect to the computing device 802. It is understood that there may be any number of input/output port(s) 808 on the computing device 802. For example, the input/output port(s) 808 provides a means for the computing device 802 to receive signals and/or data from an external device connected to the computing device 802 via the one or more cables. As another example, the input/output port(s) 808 provide a means for the computing device 802 to send signals and/or data to an external device connected to the computing device 802 via the one or more cables. The input/output component(s) 810 can include one or more components that support the input/output port(s) 808 such as, but not limited to, a switch, a push button, a pressure mat, a float switch, a keypad, a radio receive, or a combination thereof.

The network adapter 812 can be any type of network interface controller that is configured to provide a means for communicating over a network 820 with another computing device, such as a remote computing device 822. For example, the remote computing device 822 can be a user device such as a cellular-phone, a smartphone, a tablet, a laptop, or a combination thereof. The power supply 814 is configured to convert alternating high voltage current (e.g., AC) into direct current (e.g., DC) to provide power to the other components (e.g., the processor 804, the display adapter 806, the one or more input/output port(s) 808, the one or more input/output component(s) 810, the network adapter 812, and the memory 816) of the computing device 802.

Additionally, the memory 816 can be a mass storage device and/or a system memory such as a hard disk drive, a memory card, a solid-state drive, RAM, or a combination thereof. The memory 816 is configured to provide storage for instructions and data associated with the operation of the computing device 802. The memory 816 can generally include an operating system 824, sensor detection software 826, and sensor detection data 828 to perform one or more operations described in more detail herein. For example, the operating system 824 is configured to manage and/or process any of the data and/or instructions associated with the sensor detection software 826 and/or sensor detection data 828, as described in more detail herein.

Furthermore, a system bus 830 is also included within the computing device 802 that is configured to couple each of the various components (e.g., the processor 804, the display adapter 806, the one or more input/output port(s) 808, the one or more input/output component(s) 810, the network adapter 812, the power supply 814, and the memory 816) of the computing device 802. It is also understood that each of the components of the computing device 802, and the functionality associated with each of the components of the computing device 802, may be implemented within the remote computing device 822. While the operating environment illustrated within FIG. 9 depicts a particular configuration associated with at least the computing device 802, the network 820, and the remote computing device 822, it is understood that the operating environment may be configured in any way.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system comprising:
a plurality of targets arranged with respect to a testing lane, wherein the plurality of targets are configured as multisensor targets with each target of the plurality of targets having a plurality of calibration elements configured to allow detection by one or more sensors of a vehicle, the plurality of detection elements including one or more elements configured for lidar detection, one or more elements configured for camera detection, and one or more elements configured for radar detection, wherein the testing lane is configured to allow the vehicle to traverse the testing lane between the plurality of targets to detect the plurality of detection elements, and wherein the testing lane is configured to allow determination of one or more motion constraints from the one or more sensors and an Inertial Measurement Unit (IMU) and determination of one or more constraints between the IMU and the vehicle to generate IMU data; and
a calibration system configured to:
receive detection data and the IMU data from the vehicle as the vehicle traverses the testing lane, the detection data corresponding to lidar detections by the one or more sensors of the vehicle, camera detections by the one or more sensors of the vehicle, and radar detections by the one or more sensors of the vehicle;
process the received detection data and the IMU data using a calibration algorithm; and
generating one or more calibration parameters for the one or more sensors of the vehicle based on the processing.

2. The system of claim 1, wherein the calibration system is further configured to use the one or more calibration parameters to generate a valid L3 calibration of the one or more sensors of the vehicle, thereby allowing L3 autonomous operation of the vehicle.

3. The system of claim 2, wherein a spacing between one or more targets of the plurality of targets is different than a spacing between one or more other targets of the plurality of targets, and an orientation of one or more of the targets of the plurality of targets is different than an orientation one or more other targets of the plurality of targets, the spacing and orientation configured to allow collection of data by the one or more sensors of the vehicle to allow for the valid L3 calibration.

4. The system of claim 3, wherein one or more targets of the plurality of targets are positioned along a first side of the testing lane and one or more targets of the plurality of targets are positioned on a second side of the testing lane, wherein the first side of the testing lane is on a opposite side to the second side of the testing lane relative to the vehicle traversing between the plurality of targets.

5. The system of claim 1, wherein the plurality of targets are double sided having a first side and a second side opposite the first side, wherein a first set of calibration elements on the first side is different than a second set of calibration elements on the second side, and wherein the first set of calibration elements are configured for detection by one or more sensors of the vehicle that are forward facing and the second set of calibration elements are configured for detection by one or more sensors of the vehicle that are rearward facing.

6. The system of claim 1, wherein the one or more elements configured for lidar detection comprise one or more cutouts, the one or more elements configured for camera detection comprise one or more visual tags, and the one or more elements configured for radar detection comprises one or more radar targets as corner reflectors.

7. The system of claim 6, wherein the one or more cutouts, the one or more visual tags, and the one or more radar targets are arranged on at least one surface of the plurality of targets to allow for collection of detection data by the one or more sensors of the vehicle for L3 calibration.

8. The system of claim 6, wherein the one or more cutouts are arranged at a center portion of the plurality of targets, the one or more visual tags are arranged along a top portion, the center portion, and a bottom portion of the plurality of targets, and the one or more radar targets are arranged at a bottom portion of the plurality of targets.

9. The system of claim 6, wherein the one or more cutouts comprise four cutouts arranged in a symmetrical configuration forming an evenly spaced square configuration at a center portion of the plurality of targets, the one or more visual tags comprise sixteen visual tags configured as visual fiducial markers with six of the visual tags arranged in a symmetrical rectangular configuration at a top portion of the plurality of targets, four of the visual tags arranged in a diamond configuration at the center portion of the plurality of targets with a visual tag in a center of the diamond configuration, and five of the visual tags arranged in a U-shaped configuration at a bottom portion of the plurality of targets, each visual tag having a different visual fiducial pattern than other visual tags, and the one or more radar targets comprise one radar target positioned at the bottom portion of the plurality of targets within the U-shaped configuration of the visual tags.

10. The system of claim 1, wherein one or more targets of the plurality of targets are movable targets relative to the testing lane and one or more targets of the plurality of targets are fixed targets and non-movable with respect to the testing lane.

11. The system of claim 1, wherein the calibration system is further configured to process the received detection data using an optimization to estimate a plurality of parameters including a plurality of vehicle states at each of a plurality of keyframe timestamps, a plurality of poses of the plurality of targets, and a plurality of extrinsic calibrations.

12. The system of claim 11, wherein a plurality of constraints are used in the optimization, wherein the plurality of constraints include sensor factors.

13. The system of claim 1, wherein the calibration algorithm is configured to optimize a non-linear least squares optimization problem using a plurality of cost functions related to 3D-2D reprojection errors from camera target detection, errors from lidar and radar target detection, 6D-6D errors from sensor odometries, a vehicle kinematic model, and prior information as CAD values.

14. The system of claim 1, wherein the calibration system is further configured to receive detection data from the vehicle as the vehicle is stopped at a plurality of points along the testing lane, and wherein a location of each of the points and a time period that the vehicle stops at each point of the plurality of points is defined.

15. A method comprising:
receiving detection data from a vehicle as the vehicle traverses a testing lane, the detection data corresponding to lidar detections by one or more sensors of the vehicle, camera detections by one or more sensors of the vehicle, and radar detections by one or more sensors of the vehicle, wherein a plurality of targets are arranged with respect to the testing lane, wherein the plurality of targets are configured as multisensor targets with each target of the plurality of targets having a plurality of calibration elements configured to allow detection by the one or more sensors of the vehicle, and wherein the testing lane is configured to allow determination of one or more motion constraints from the one or more sensors and an Inertial Measurement Unit (IMU) and determination of one or more constraints between the IMU and the vehicle to generate IMU data;
processing, by a processor, the received detection data and IMU data using a calibration algorithm; and
generating, by the processor, one or more calibration parameters for the one or more sensors of the vehicle based on the processing.

16. The method of claim 15, wherein the plurality of detection elements include one or more elements configured for lidar detection, one or more elements configured for camera detection, and one or more elements configured for radar detection, wherein the testing lane is configured to allow a vehicle to traverse the testing lane between the plurality of targets to detect the plurality of detection elements.

17. The method of claim 15, further comprising using the one or more calibration parameters to generate a valid L3 calibration of the one or more sensors of the vehicle, thereby allowing L3 autonomous operation of the vehicle, wherein a spacing between one or more targets of the plurality of targets is different than a spacing between one or more other targets of the plurality of targets, and an orientation of one or more of the targets of the plurality of targets is different than an orientation one or more other targets of the plurality of targets, the spacing and orientation configured to allow collection of data by the one or more sensors of the vehicle to allow for the valid L3 calibration.

18. The method of claim 17, wherein the plurality of targets are double sided having a first side and a second side opposite to the first side, wherein a first set of calibration elements on the first side is different than a second set of calibration elements on the second side, and wherein the first set of calibration elements are configured for detection by one or more sensors of the vehicle that are forward facing and the second set of calibration elements are configured for detection by one or more sensors of the vehicle that are rearward facing.

19. The method of claim 15, further comprising processing the received detection data using an optimization to estimate a plurality of parameters including a plurality of vehicle states at each of a plurality of keyframe timestamps, a plurality of poses of the plurality of targets, and a plurality of extrinsic calibrations, wherein a plurality of constraints are used in the optimization, wherein the plurality of constraints include sensor factors.

20. One or more non-transitory computer-readable media storing processor-executable instructions that, when executed by at least one processor, cause the at least one processor to:
receive detection data from a vehicle as the vehicle traverses a testing lane, the detection data corresponding to lidar detections by one or more sensors of the vehicle, camera detections by one or more sensors of the vehicle, and radar detections by one or more sensors of the vehicle, wherein a plurality of targets are arranged with respect to the testing lane, and wherein the plurality of targets are configured as multisensor targets with each target of the plurality of targets having a plurality of calibration elements configured to allow detection by the one or more sensors of the vehicle, and wherein the testing lane is configured to allow determination of one or more motion constraints from the one or more sensors and an Inertial Measurement Unit (IMU) and determination of one or more constraints between the IMU and the vehicle to generate IMU data;
process the received detection data and IMU data using a calibration algorithm; and
generate one or more calibration parameters for the one or more sensors of the vehicle based on the processing.
